(19) United States
(12) Patent Application Publication
(10) Pub. No.: US 2024/0266628 A1
(43) Pub. Date: Aug. 8, 2024

(54) BATTERY PACK

(71) Applicant: MURATA MANUFACTURING CO., LTD., Kyoto (JP)

(72) Inventors: Etsuko HONDA, Kyoto (JP); Yuta NIKAIDO, Kyoto (JP)

(21) Appl. No.: 18/403,052

(22) Filed: Jan. 3, 2024

(30) Foreign Application Priority Data
Feb. 8, 2023 (JP) 2023-017704
Oct. 10, 2023 (JP) 2023-175535

(51) Int. Cl. H01M 10/613; H01M 10/643; H01M 10/653; H01M 50/213; H01M 50/514; H01M 50/533

(52) U.S. Cl. CPC H01M 10/613; H01M 10/643; H01M 10/653; H01M 50/213; H01M 50/514; H01M 50/533

(57) ABSTRACT

A battery pack is provided according to an aspect of the present technology and includes a plurality of secondary batteries, a tab that electrically connects the plurality of secondary batteries, and a heat absorbing member in which a heat absorbing agent is encapsulated in an insulating container. The heat absorbing member is provided between the secondary battery and the tab and in at least a part of a peripheral region of a connection portion between the secondary battery and the tab.

### CROSS REFERENCE TO RELATED APPLICATIONS

The present application claims priority to Japanese patent application no. 2023-175535, filed on Oct. 10, 2023, and Japanese patent application no. 2023-017704, filed on Feb. 8, 2023, the entire contents of which are incorporated herein by reference.

### BACKGROUND

The present technology relates to a battery pack.

Since electronic equipment has been widely spread, a battery has been developed as a power source applied to the electronic equipment. In this case, in order to handle a plurality of batteries easily and safely, a battery pack including the plurality of batteries has been proposed.

Various studies have been made on the technology related to the configuration of the battery pack. For example, a conductor with a heat absorber is disclosed that suppresses a temperature rise at the time of abnormal energization.

### SUMMARY

The present technology relates to a battery pack.

The battery included in the battery pack may generate abnormal heat and eject gas. As such, another battery adjacent to the battery that has abnormally generated heat is heated by the jetting gas, which may cause abnormal heat generation and explosion induction. In the battery pack, it is desired to reduce the possibility of such explosion induction. It is desirable to provide a battery pack capable of reducing the possibility of explosion induction.

A battery pack according to an embodiment of the present technology includes a plurality of secondary batteries, a tab that electrically connects the plurality of secondary batteries, and a heat absorbing member in which a heat absorbing agent is encapsulated in an insulating container. The heat absorbing member is provided between the secondary battery and the tab and in at least a part of a peripheral region of a connection portion between the secondary battery and the tab.

A battery pack according to another embodiment of the present technology includes a plurality of secondary batteries, a tab that electrically connects the plurality of secondary batteries, and a heat absorbing member in which a heat absorbing agent is encapsulated in an insulating container. The secondary battery includes a first end surface and a second end surface facing each other, a positive electrode provided on the first end surface, and a negative electrode provided on the second end surface. The heat absorbing member is provided between the secondary battery and the tab and in at least a part of a peripheral region of the positive electrode.

A battery pack according to a further embodiment of the present technology includes a plurality of secondary batteries, a tab that electrically connects the plurality of secondary batteries, and a heat absorbing member in which a heat absorbing agent is encapsulated in an insulating container. The secondary battery includes a first end surface and a second end surface facing each other, a positive electrode provided on the first end surface, and a negative electrode provided on the second end surface. The first end surface of a first secondary battery in the plurality of secondary batteries and the second end surface of a second secondary battery in the plurality of secondary batteries are arranged in a same plane. The tab is electrically connected to the positive electrode on the first end surface of the first secondary battery and to the negative electrode terminal on the second end surface of the second secondary battery. The heat absorbing member is provided between the tab and the first end surface of the first secondary battery and the second end surface of the second secondary battery. The heat absorbing member is in contact with the tab.

In the battery pack according to an embodiment of the present technology, the heat absorbing member is provided between the secondary battery and the tab and in at least a part of the peripheral region of the connection portion between the secondary battery and the tab, so that the gas ejected from the secondary battery having abnormally generated heat can be cooled by the heat absorbing member. As a result, it is possible to reduce the possibility that another battery adjacent to the secondary battery that has abnormally generated heat is heated by the jetting gas to cause abnormal heat generation and explosion induction.

In the battery pack according to an embodiment of the present technology, the heat absorbing member is provided between the secondary battery and the tab and in at least a part of the peripheral region of the positive electrode, so that the gas ejected from the secondary battery having abnormally generated heat can be cooled by the heat absorbing member. As a result, it is possible to reduce the possibility that another battery adjacent to the secondary battery that has abnormally generated heat is heated by the jetting gas to cause abnormal heat generation and explosion induction.

In the battery pack according to an embodiment of the present technology, the heat absorbing member is provided between the tab and the first end surface of the first secondary battery in the plurality of secondary batteries and the second end surface of the second secondary battery in the plurality of secondary batteries, and the heat absorbing member is brought into contact with the tab, so that the gas ejected from the secondary battery having abnormally generated heat can be cooled by the heat absorbing member. As a result, it is possible to reduce the possibility that another battery adjacent to the secondary battery that has abnormally generated heat is heated by the jetting gas to cause abnormal heat generation and explosion induction.

### BRIEF DESCRIPTION OF THE FIGURES

FIG. 1 is a perspective view showing a perspective configuration example of a battery pack according to an embodiment of the present technology;

FIG. 2 is a view showing a perspective configuration example of a housed object of the battery pack;

FIG. 3 is a view showing a developed perspective configuration example of the battery pack;

FIG. 4 is a view showing a perspective configuration example of one end (positive electrode portion) of a secondary battery;

FIG. 5 is a view showing a sectional configuration example of one end (positive electrode portion) of the secondary battery;

FIG. 6 is a view showing a perspective configuration example of the other end (negative electrode portion) of the secondary battery;

FIG. 7 is a view showing a developed perspective configuration example of a part of the housed object of the battery pack;

FIG. 8 is a view showing a sectional configuration example of a positive electrode portion and a peripheral portion thereof in the battery pack;

FIG. 9 is a view showing a sectional configuration example taken along line A-A in FIG. 8;

FIG. 10 is a view showing a configuration example of a back surface of a tab of FIG. 8;

FIG. 11 is a view showing a sectional configuration example of a negative electrode portion and a peripheral portion thereof in the battery pack;

FIG. 12 is a view showing a configuration example of an upper surface of the heat absorbing member of FIG. 11;

FIG. 13 is a view showing a configuration example of a back surface of the tab of FIG. 11;

FIG. 14 is a view showing a modification of the sectional configuration of FIG. 8;

FIG. 15 is a view showing a modification of the sectional configuration of FIG. 8;

FIG. 16 is a view showing a modification of the sectional configuration of FIG. 8;

FIG. 17 is a view showing a modification of the sectional configuration of FIG. 8;

FIG. 18 is a view showing a modification of the sectional configuration of FIG. 11;

FIG. 19 is a view showing a sectional configuration example of a through-hole portion in a heat absorbing member;

FIG. 20 is a view showing a modification of the sectional configuration of the positive electrode portion and the peripheral portion thereof in the battery pack;

FIG. 21 is a view showing a modification of the developed perspective configuration of a part of the housed object of the battery pack;

FIG. 22 is a view showing a modification of the developed perspective configuration of a part of the housed object of the battery pack;

FIG. 23 is a view showing a modification of a planar configuration of the heat absorbing member;

FIG. 24 is a view showing a modification of the planar configuration of the heat absorbing member;

FIG. 25 is a view showing a modification of the planar configuration of the heat absorbing member;

FIG. 26 is a view showing a sectional configuration example of the heat absorbing member;

FIG. 27 is a view showing a developed perspective configuration example of a part of the housed object of the battery pack including the heat absorbing member of FIG. 25;

FIG. 28 is a view showing a modification of a developed perspective configuration of the battery pack; and

FIG. 29 is a view showing a perspective configuration example of a set of heat absorbing members capable of replacing the heat absorbing member of FIG. 28.

### DETAILED DESCRIPTION

The present technology will be described below in further detail including with reference to the drawings according to an embodiment.

A battery pack according to an embodiment of the present technology is described as follows.

The battery pack described herein is a power supply including a plurality of batteries, and is applied to a variety of applications such as electronic equipment. The application of the battery pack is detailed later. The type of the battery is not particularly limited, and may be a primary battery or a secondary battery. The type of the secondary battery is not particularly limited, and is specifically a lithium ion secondary battery or the like in which a battery capacity is obtained using occlusion and release of lithium ions. The number of batteries is not particularly limited, and thus can be set arbitrarily. Hereinafter, a case where the battery is a secondary battery (lithium ion secondary battery) will be described. That is, the battery pack described below is a power supply including a plurality of secondary batteries.

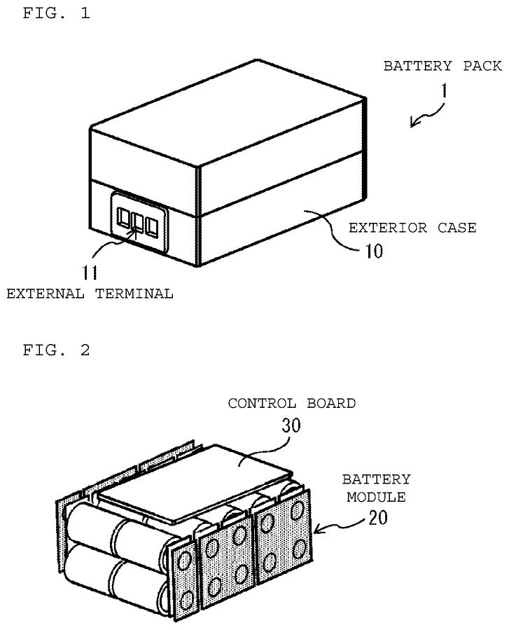

FIG. 1 shows a perspective configuration example of a battery pack 1. FIG. 2 shows a developed perspective configuration example of the housed object of the battery pack 1.

For example, as shown in FIGS. 1 and 2, the battery pack 1 includes an exterior case 10 and a battery module 20 and a control board 30 housed in the exterior case 10. The control board 30 is connected to positive and negative electrode terminals of the battery module 20, for example, and includes a circuit that measures a voltage of the battery or the battery module, detects a remaining capacity of the battery module, measures a current output from the battery module, and detects the presence or absence of an overcurrent.

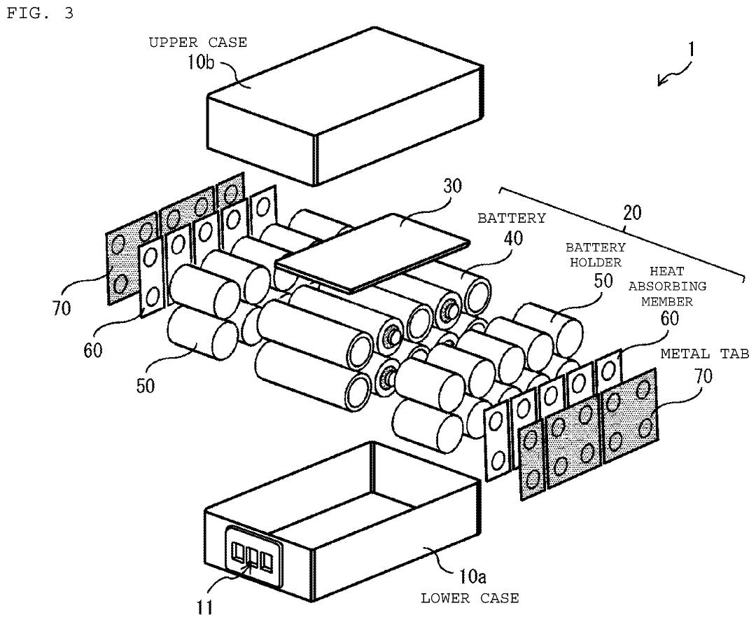

The exterior case 10 includes, for example, a lower case 10a and an upper case 10b as shown in FIG. 3. By overlapping the lower case 10a and the upper case 10b with each other, a housing space for housing the battery module 20 and the control board 30 is formed. An external terminal 11 connected to the control board 30 is provided in the exterior case 10 (for example, lower case 10a). The battery module 20 is connected to the external terminal 11 with the control board 30 interposed therebetween.

The battery pack 1 has a discharge mode in which power output from the battery module 20 is supplied to a load via the external terminal 11. The battery pack 1 may further have a charge mode in which power supplied from a power supply, connected to the external terminal 11, via the external terminal 11 is accumulated in the battery module 20. A battery 40 described later is a secondary battery, where the control board 30 switches between the discharge mode and the charge mode according to the type of a connected object connected to the external terminal 11. The battery 40 described later is a primary battery, where the control board 30 executes only the discharge mode.

The battery module 20 includes a plurality of the batteries 40 and a plurality of metal tabs 70. The plurality of batteries 40 is electrically connected via a plurality of the metal tabs 70. For example, the plurality of batteries 40, which are some of the plurality of batteries 40, are connected in series to each other by the plurality of metal tabs 70, and the plurality of batteries 40 connected in series to each other is referred to as a series unit, where the plurality of series units are connected in parallel to each other by the plurality of metal tabs 70. The connection mode of the plurality of batteries 40 is not limited to the above.

Each of the metal tabs 70 is formed of, for example, a metal lead plate. Each of the batteries 40 is a primary battery or a secondary battery. The type of the secondary battery is not particularly limited, and includes, for example, a lithium ion secondary battery or the like in which the battery capacity is obtained using occlusion and release of lithium ions. Hereinafter, a case where each of the batteries 40 is a secondary battery (lithium ion secondary battery) will be described according to an embodiment. That is, the battery pack 1 described below is a power supply including a plurality of secondary batteries.

The battery module 20 further includes a battery holder 50 that supports the plurality of batteries 40, and a plurality of heat absorbing members 60 provided between the plurality of batteries 40 and the plurality of metal tabs 70. The heat absorbing member 60 will be described in detail later.

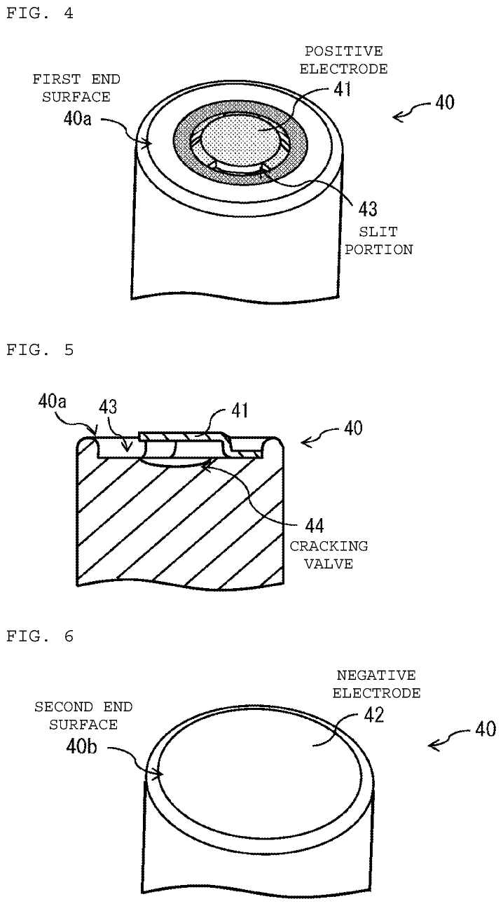

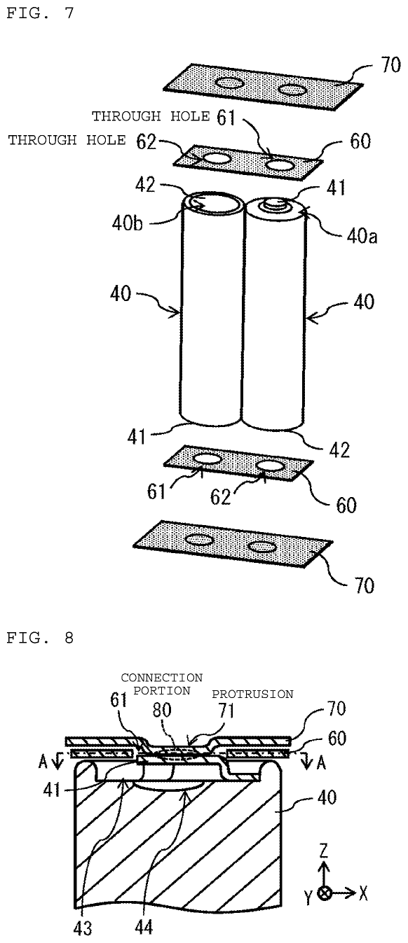

FIG. 4 shows a perspective configuration example of one end of the battery 40. FIG. 5 shows a sectional configuration example of one end of the battery 40. FIG. 6 shows a perspective configuration example of the other end of the battery 40.

The battery 40 includes a first end surface 40a and a second end surface 40b facing each other, a positive electrode 41 provided on the first end surface 40a, and a negative electrode 42 provided on the second end surface 40b. The battery 40 has, for example, a columnar shape in which the first end surface 40a and the second end surface 40b extend in directions facing each other, and each of the first end surface 40a and the second end surface 40b has a circular shape. The shape of the battery 40 is not limited to a columnar shape. The shapes of the first end surface 40a and the second end surface 40b are not limited to the circular shape.

The positive electrode 41 is made of a metal member. The positive electrode 41 has a projecting shape on the first end surface 40a (see FIG. 5). In the first end surface 40a, one or a plurality of slit portions 43 is provided around the positive electrode 41. In the first end surface 40a, a gap is provided on the back surface side of the positive electrode 41, and this gap communicates with one or a plurality of slit portions 43. A cracking valve 44 is provided at the bottom of the gap. The cracking valve 44 has a function of discharging a gas generated in the battery 40 to the outside when the battery 40 generates abnormal heat. The negative electrode 42 is made of a metal member. The negative electrode 42 forms a flat surface on the second end surface 40b.

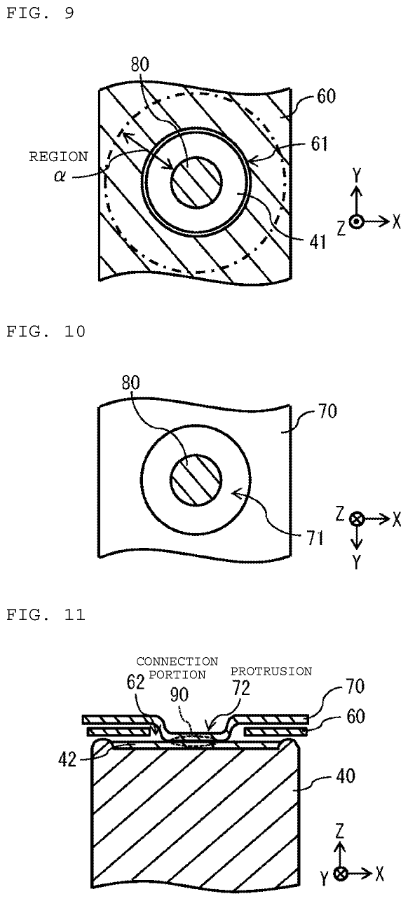

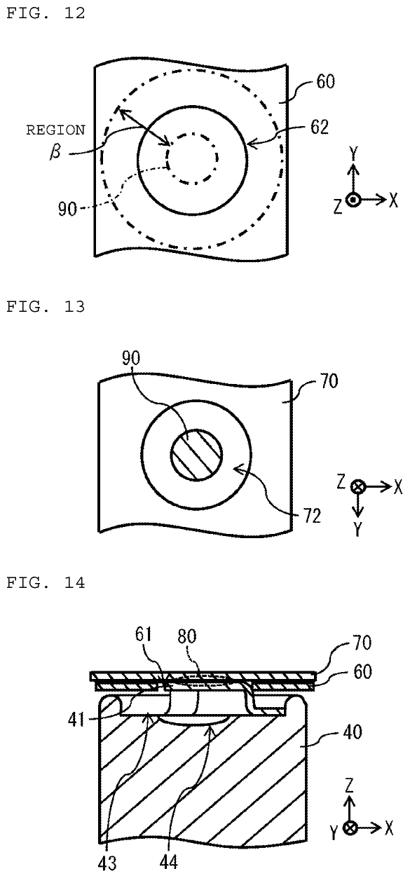

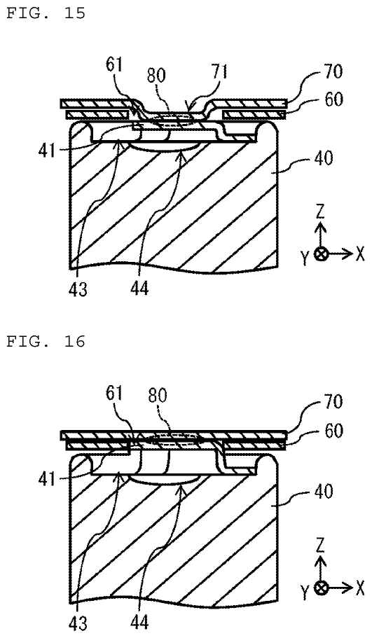

FIG. 7 shows a developed perspective configuration example a part of the housed object of the battery pack 1. FIG. 8 shows a sectional configuration example of a positive electrode portion and a peripheral portion thereof in the battery pack 1. FIG. 9 shows a sectional configuration example taken along line A-A in FIG. 8. FIG. 10 shows a configuration example of a back surface of the tab of FIG. 8. FIG. 11 shows a sectional configuration example of a negative electrode portion and a peripheral portion thereof in the battery pack 1. FIG. 12 shows a configuration example of an upper surface of the heat absorbing member 60 of FIG. 11. FIG. 13 shows a configuration example of a back surface of the tab of FIG. 11.

It is assumed that the plurality of batteries 40 are arranged side by side in a two-dimensional direction (a first direction and a second direction orthogonal to the first direction) orthogonal to the longitudinal direction of the battery 40 (a direction in which the first end surface 40a and the second end surface 40b face each other in the battery 40). At this time, the first end surface 40a of one battery 40 (first battery) in the plurality of batteries 40 provided in the battery pack 1 and the second end surface 40b of another battery 40 (second battery) in the plurality of batteries 40 provided in the battery pack 1 are arranged in the same plane. For example, the plurality of first end surfaces 40a and the plurality of second end surfaces 40b are alternately arranged in at least one of the first direction and the second direction in the same plane. The plurality of metal tabs 70 are arranged in a manner of facing each other with the plurality of batteries 40, provided in the battery pack 1, sandwiched in the extending direction of the batteries 40. In the present description, the “extending direction of the batteries 40” is a direction parallel to a direction in which the first end surface 40a and the second end surface 40b face each other in a case where the batteries 40 have a columnar shape extending in a direction in which the first end surface 40a and the second end surface 40b face each other.

The metal tab 70 is electrically connected to the positive electrode 41 on the first end surface 40a of the first battery and to the negative electrode 42 on the second end surface 40b of the second battery. The electrical connection between the metal tab 70 and the positive electrode 41 is achieved by, for example, a connection portion 80 as shown in FIGS. 8 to 10. The electrical connection between the metal tab 70 and the negative electrode 42 is achieved by, for example, a connection portion 90 as shown in FIGS. 11 to 13. The battery pack 1 includes the connection portions 80 and 90. The connection portion 80 corresponds to a specific example of a first connection portion of an embodiment of the present technology. The connection portion 90 corresponds to a specific example of a second connection portion of an embodiment of the present technology.

The connection portion 80 is a portion where a protrusion 71 of the metal tab 70 and the positive electrode 41 are connected. The protrusion 71 is provided at a position facing the positive electrode 41 in the metal tab 70. The protrusion 71 has a shape protruding in the positive electrode 41 direction. In the present embodiment, the protrusion 71 and the positive electrode 41 are connected by welding. For example, laser welding or resistance welding is used for welding. The connection portion 80 is not limited to the above, and the protrusion 71 and the positive electrode 41 may be connected by a method other than welding. For example, connection by screwing, connection by crimping, or the like may be used.

The connection portion 90 is a portion where a protrusion 72 of the metal tab 70 and the negative electrode 42 are connected. The protrusion 72 is provided at a position facing the negative electrode 42 in the metal tab 70. The protrusion 72 has a shape protruding in the negative electrode 42 direction. In the present embodiment, the protrusion 72 and the negative electrode 42 are connected by welding. For example, laser welding or resistance welding is used for welding. The connection portion 90 is not limited to the above, and the protrusion 72 and the negative electrode 42 may be connected by a method other than welding. For example, connection by screwing, connection by crimping, or the like may be used.

The heat absorbing member 60 is provided between the first end surface 40a of the first battery and the second end surface 40b of the second battery, and the metal tab 70, and in at least a part of a peripheral region of the connection portions 80 and 90. The heat absorbing member 60 is in contact with the first end surface 40a of the first battery and the second end surface 40b of the second battery. The heat absorbing member 60 may further be in contact with the metal tab 70.

The peripheral region of the connection portion 80 is a region between the metal tab 70 and the first end surface 40a, and refers to an annular region a excluding the connection portion 80 in a region facing the first end surface 40a in a plan view of the first end surface 40a (see FIG. 9). For example, it is desirable from the viewpoint of cooling injection gas that the heat absorbing member 60 is provided in the whole or a part of the region facing the slit portion 43 in the region a in a plan view of the first end surface 40a. The peripheral region of the connection portion 90 is a region between the metal tab 70 and the second end surface 40b, and refers to an annular region (excluding the connection portion 90 in a region facing the second end surface 40b in a plan view of the second end surface 40b (see FIG. 12).

The heat absorbing member 60 has a through hole 61 into which the connection portion 80 is inserted and a through hole 62 into which the connection portion 90 is inserted. At this time, the heat absorbing member 60 is disposed so as to surround the periphery of the connection portions 80 and 90. The through hole 61 corresponds to a specific example of a first through hole of an embodiment of the present technology. The through hole 62 corresponds to a specific example of a second through hole of an embodiment of the present technology.

The through hole 61 may be configured such that the inner surface of the through hole 61 is in contact with a side surface of the connection portion 80, or may be configured such that the inner surface of the through hole 61 is slightly away from the side surface of the connection portion 80. The connection portion 80 may be inserted into the through hole 61, or the connection portion 80 may be fitted into the through hole 61. Insertion refers to a state in which at least a part of the connection portion 80 is inserted into the through hole 61. Fitting refers to a state in which at least a part of the connection portion 80 is inserted into the through hole 61 without a gap. When the connection portion 80 is inserted into the through hole 61, the connection portion 80 may have, for example, a circular shape in plan view, and the through hole 61 may have, for example, a circular shape having a diameter equal to or larger than a diameter of the connection portion 80 in plan view.

For example, as shown in FIG. 14, a convex portion of the positive electrode 41 may be inserted into the through hole 61, or for example, as shown in FIG. 15, a protrusion 71 of the metal tab 70 may be inserted into the through hole. For example, as shown in FIG. 16, the convex portion of the positive electrode 41 may be fitted into the through hole 61, or for example, as shown in FIG. 17, the protrusion 71 of the metal tab 70 may be fitted into the through hole. FIGS. 14 and 16 show an example in which the protrusion 71 is omitted in the metal tab 70.

When the convex portion of the positive electrode 41 is inserted into the through hole 61, the heat absorbing member 60 is provided between the first end surface 40a of the first battery and the second end surface 40b of the second battery, and the metal tab 70, and in at least a part of a peripheral region of the positive electrode 41. The peripheral region of the positive electrode 41 is a region between the metal tab 70 and the first end surface 40a, and refers to an annular region excluding the convex portion of the positive electrode 41 in the region facing the first end surface 40a in a plan view of the first end surface 40a. For example, it is desirable from the viewpoint of cooling the injection gas that for example, in a plan view of the first end surface 40a, the heat absorbing member 60 is provided in the whole or a part of the region facing the slit portion 43 in the annular region excluding the convex portion of the positive electrode 41 in the region facing the first end surface 40a.

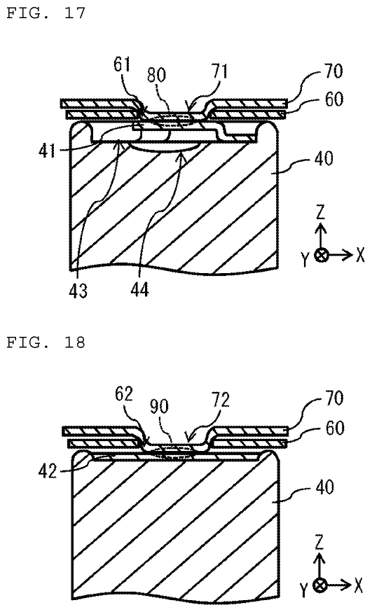

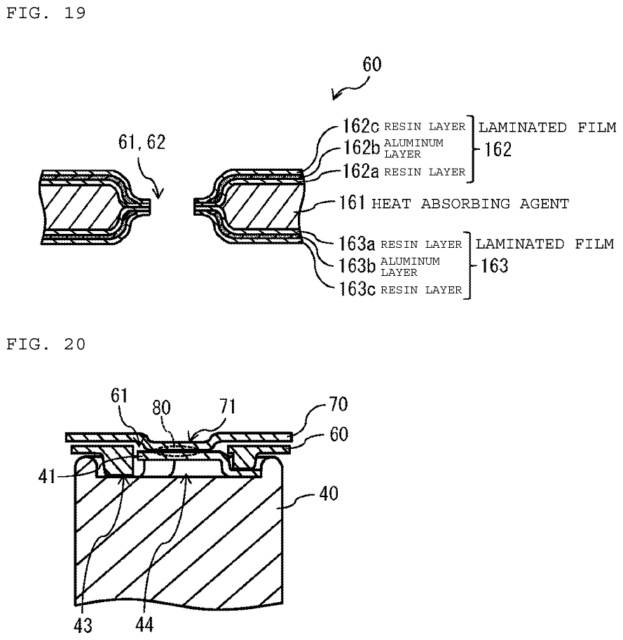

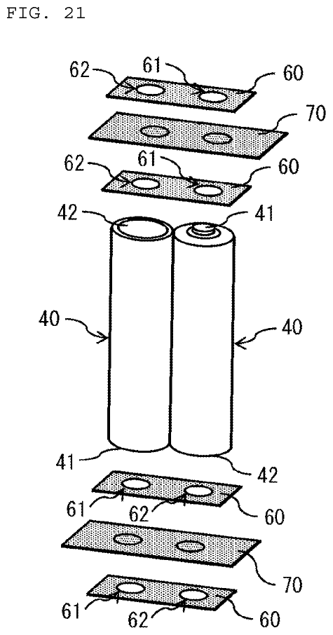

The through hole 62 may be configured such that the inner surface of the through hole 62 is in contact with a side surface of the connection portion 90, or may be configured such that the inner surface of the through hole 62 is slightly away from the side surface of the connection portion 90. The connection portion 90 may be inserted into the through hole 62, or the connection portion 90 may be fitted into the through hole 62. When the connection portion 90 is inserted into the through hole 62, the connection portion 90 may have, for example, a circular shape in plan view, and the through hole 62 may have, for example, a circular shape having a diameter equal to or larger than a diameter of the connection portion 90 in plan view. For example, as shown in FIG. 11, the convex portion 72 of the metal tab 70 may be inserted into the through hole 62, or for example, as shown in FIG. 18, the convex portion 72 of the metal tab 70 may be fitted into the through hole.

In either case, the heat absorbing member 60 is provided so as to cover one or the plurality of slit portions 43.

FIG. 19 shows a sectional configuration example of the through holes 61 and 62 and the periphery thereof in the heat absorbing member 60. For example, as shown in FIG. 19, the heat absorbing member 60 has a configuration in which a heat absorbing agent 161 is encapsulated in an insulating container. For example, as shown in FIG. 19, the insulating container includes laminated films 162 and 163 sandwiching the heat absorbing agent 161. The laminated films 162 and 163 are subjected to lamination processing. The laminated film 162 corresponds to a specific example of a first laminate layer of an embodiment of the present technology. The laminated film 163 corresponds to a specific example of a second laminate layer of an embodiment of the present technology.

For example, as shown in FIG. 19, the laminated film 162 is formed by stacking a resin layer 162a, an aluminum layer 162b, and a resin layer 162c in this order from the heat absorbing agent 161 side. For example, as shown in FIG. 19, the laminated film 163 is formed by stacking a resin layer 163a, an aluminum layer 163b, and a resin layer 163c in this order from the heat absorbing agent 161 side. The resin layers 162a, 162c, 163a, and 163c contain, for example, a resin material such as polyethylene, polystyrene, polypropylene, or polycarbonate. The aluminum layers 162b and 163b include, for example, an aluminum foil.

The heat absorbing agent 161 includes, for example, a liquid containing water or a hydrogel. When a hydrogel is used as the heat absorbing agent 161, it is preferable to use a synthetic polymer gel. Examples of the material of the synthetic polymer gel include sodium polyacrylate (PNaAA), polyvinyl alcohol (PVA), polyhydroxyethyl methacrylate (PHE-MA), and silicone hydrogel.

Next, effects of the battery pack 1 will be described according to an embodiment.

In the present embodiment, the heat absorbing member 60 is provided between the battery 40 and the metal tab 70, and in at least a part of the peripheral region of the connection portions 80 and 90. As a result, when the gas ejected from the battery 40 that has abnormally generated heat comes into contact with the heat absorbing member 60, the laminated films 162 and 163 of the heat absorbing member 60 are broken, and the heat absorbing agent 161 leaks out. As a result, the jetting gas can be cooled by the heat absorbing agent 161. Therefore, it is possible to reduce the possibility that another battery 40 adjacent to the battery 40 that has abnormally generated heat is heated by the jetting gas to cause abnormal heat generation and explosion induction.

In the present embodiment, the heat absorbing member 60 is provided between the battery 40 and the metal tab 70, and in at least a part of the peripheral region of the positive electrode 41. As a result, when the gas ejected from the battery 40 that has abnormally generated heat comes into contact with the heat absorbing member 60, the laminated films 162 and 163 of the heat absorbing member 60 are broken, and the heat absorbing agent 161 leaks out. As a result, the jetting gas can be cooled by the heat absorbing agent 161. Therefore, it is possible to reduce the possibility that another battery 40 adjacent to the battery 40 that has abnormally generated heat is heated by the jetting gas to cause abnormal heat generation and explosion induction.

In the present embodiment, the heat absorbing member 60 is provided with the through hole 61 into which the connection portion 80 is inserted or fitted, and the through hole 62 into which the connection portion 90 is inserted or fitted. As a result, it is possible to reduce the possibility of further abnormal heat generation and explosion induction while maintaining the electrical connection between the battery 40 and the metal tab 70. In particular, when the connection portions 80 and 90 are fitted into the through holes 61 and 62, since there is no passage for the jetting gas in the through holes 61 and 62, the jetting gas cannot pass through the through holes 61 and 62 without coming into contact with the heat absorbing member 60. As a result, since the jetting gas can be reliably brought into contact with the heat absorbing member 60, the possibility of explosion induction can be further reduced.

In the present embodiment, when the connection portions 80 and 90 have a circular shape in plan view and the through holes 61 and 62 have a circular shape having a diameter equal to or larger than the diameter of the connection portions 80 and 90 in plan view, the connection portions 80 and 90 can be easily inserted or fitted into the through holes 61 and 62 in an assembly process of the battery pack 1.

In the present embodiment, the heat absorbing member 60 is provided so as to cover one or the plurality of slit portions 43. As a result, the gas jetted from the battery 40 that has abnormally generated heat easily comes into contact with the heat absorbing member 60. As a result, the heat absorbing agent 161 easily leaks from the heat absorbing member 60, and the cooling of the jetting gas can be promoted by the leaked heat absorbing agent 161. Therefore, the possibility of causing further abnormal heat generation or explosion induction can be reduced.

In the present embodiment, the heat absorbing member 60 is in contact with the first end surface 40a of the first battery and the second end surface 40b of the second battery. As a result, when abnormal heat generation occurs in any one of the first battery and the second battery in contact with the heat absorbing member 60, cooling can be performed by the heat absorbing agent 161 leaking from the heat absorbing member 60. Therefore, the possibility of causing further abnormal heat generation or explosion induction can be reduced.

In the present embodiment, the heat absorbing member 60 is also in contact with the metal tab 70. As a result, the heat propagated from the battery 40 that has abnormally generated heat can be dissipated to the metal tab 70. As a result, the heat of the battery 40 that has abnormally generated heat is continuously cooled by the heat absorbing agent 161, so that the temperature of the battery 40 that has abnormally generated heat can be reduced. Therefore, propagation of the heat from the battery 40 that has abnormally generated heat to another adjacent battery 40 can be suppressed, and the possibility of further abnormal heat generation and explosion induction can be reduced.

In the present embodiment, the first end surface 40a and the second end surface 40b are arranged in the same plane, and the metal tab 70 is electrically connected to the positive electrode 41 and the negative electrode 42. In addition, the heat absorbing member 60 is provided between the first end surface 40a and the second end surface 40b, and the metal tab 70, and in at least a part of the peripheral region of the connection portions 80 and 90. As a result, when the gas ejected from the battery 40 that has abnormally generated heat comes into contact with the heat absorbing member 60, the laminated films 162 and 163 of the heat absorbing member 60 are broken, and the heat absorbing agent 161 leaks out. As a result, the jetting gas can be cooled by the heat absorbing agent 161. Therefore, it is possible to reduce the possibility that another battery 40 adjacent to the battery 40 that has abnormally generated heat is heated by the jetting gas to cause abnormal heat generation and explosion induction.

In the present embodiment, the plurality of first end surfaces 40a and the plurality of second end surfaces 40b are alternately arranged in the same plane, and each of the metal tabs 70 is electrically connected to the positive electrode 41 and the negative electrode 42. In addition, each of the heat absorbing members 60 is provided between the first end surface 40a and the second end surface 40b, and the metal tab 70, and in at least a part of the peripheral region of the connection portions 80 and 90. As a result, when the gas ejected from the battery 40 that has abnormally generated heat comes into contact with the heat absorbing member 60, the laminated films 162 and 163 of the heat absorbing member 60 are broken, and the heat absorbing agent 161 leaks out. As a result, the jetting gas can be cooled by the heat absorbing agent 161. Therefore, it is possible to reduce the possibility that another battery 40 adjacent to the battery 40 that has abnormally generated heat is heated by the jetting gas to cause abnormal heat generation and explosion induction.

In the present embodiment, the first end surface 40a and the second end surface 40b are arranged in the same plane, and the metal tab 70 is electrically connected to the positive electrode 41 and the negative electrode 42. In addition, the heat absorbing member 60 is provided between the first end surface 40a and the second end surface 40b, and the metal tab 70, and the heat absorbing member 60 is in contact with the metal tab 70. As a result, the heat propagated from the battery 40 that has abnormally generated heat can be dissipated to the metal tab 70. As a result, the heat of the battery 40 that has abnormally generated heat is continuously cooled by the heat absorbing agent 161, so that the temperature of the battery 40 that has abnormally generated heat can be reduced. As a result, propagation of the heat from the battery 40 that has abnormally generated heat to another adjacent battery 40 can be suppressed, and the possibility of further abnormal heat generation and explosion induction can be reduced.

Next, one or more modifications of the battery pack 1 according to one or more embodiments will be described.

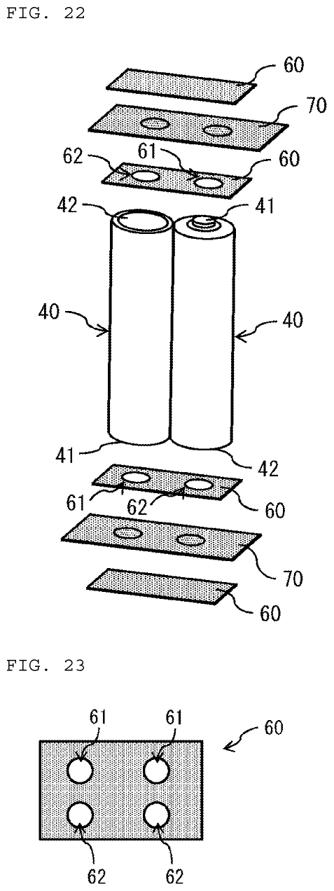

In an embodiment, the heat absorbing member 60 may also be provided inside one or the plurality of slit portions 43, for example, as shown in FIG. 20. In such a configuration, the gas jetted from the battery 40 that has abnormally generated heat more easily comes into contact with the heat absorbing member 60. As a result, the heat absorbing agent 161 more easily leaks from the heat absorbing member 60, and the cooling of the jetting gas can be promoted by the leaked heat absorbing agent 161. Therefore, the possibility of causing further abnormal heat generation or explosion induction can be further reduced.

In an embodiment, the heat absorbing member 60 is provided between the battery 40 and the metal tab 70. As described herein, the heat absorbing member 60 is provided between the first end surface 40a of the first battery and the second end surface 40b of the second battery, and the metal tab 70. However, for example, heat absorbing member 60 may be further provided at a position facing the battery 40 via the metal tab 70 as shown in FIG. 21 according to an embodiment. At this time, the newly provided heat absorbing member 60 is bonded to the metal tab 70 by, for example, a double-sided tape or the like, and is in contact with the metal tab 70 via the double-sided tape or the like. The heat absorbing member 60 may be fixed to the metal tab 70. As shown in FIG. 21, for example, the heat absorbing member 60 may be further provided at a position facing the first end surface 40a of the first battery and the second end surface 40b of the second battery via the metal tab 70. At this time, the newly provided heat absorbing member 60 is bonded to the metal tab 70 by, for example, a double-sided tape or the like, and is in contact with the metal tab 70 via the double-sided tape or the like. The heat absorbing member 60 may be fixed to the metal tab 70.

In such a configuration, the heat of the metal tab 70 can be absorbed by the newly provided heat absorbing member 60. As a result, the possibility of further abnormal heat generation and explosion induction can be further reduced as compared with the above embodiment.

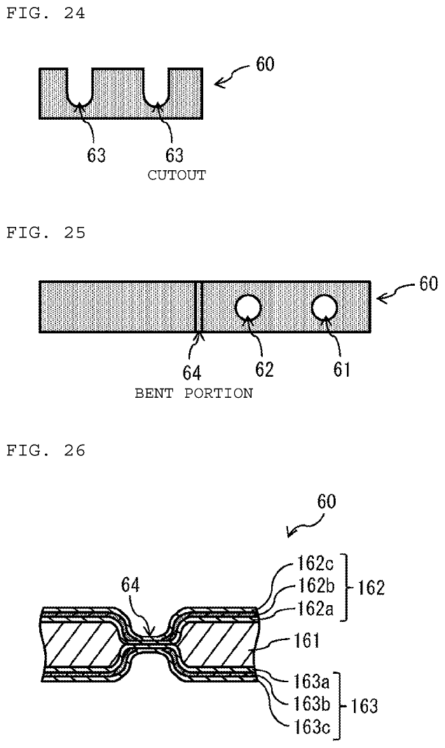

In the present modification, for example, as shown in FIG. 21, the heat absorbing member 60 may have the same configuration as the heat absorbing member 60 provided between the battery 40 and the metal tab 70. In such a configuration, all the heat absorbing members 60 can be made common, and the manufacturing cost can be reduced. In addition, by providing the through holes 61 and 62 also in the heat absorbing member 60, the heat absorbing agent 161 can leak from the places of the through holes 61 and 62 when heat is transferred to the heat absorbing member 60, so that the metal tab 70 can be effectively cooled. In the present modification, for example, as shown in FIG. 22, the heat absorbing member 60 may have a configuration different from the heat absorbing member 60 provided between the battery 40 and the metal tab 70. In the heat absorbing member 60, for example, the through holes 61 and 62 may be omitted. Even in such a configuration, the possibility of further abnormal heat generation and explosion induction can be further reduced as compared with the above embodiment.

As shown in FIG. 23, for example, the heat absorbing member 60 may have two through holes 61 and two through holes 62. In such a configuration, since one heat absorbing member 60 is provided for four batteries 40, a volume of the heat absorbing member 60 in the battery pack 1 can be increased as compared with the above embodiment. As a result, the possibility of further abnormal heat generation and explosion induction can be further reduced as compared with the above embodiment.

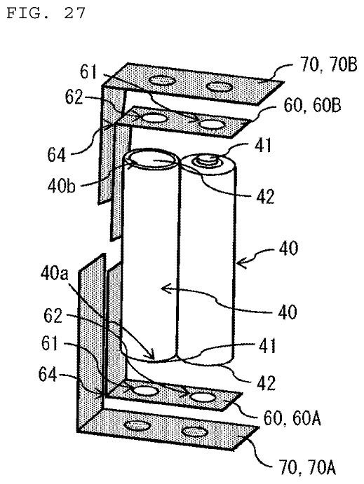

As shown in FIG. 24, for example, the heat absorbing member 60 may have a cutout 63 instead of the through holes 61 and 62. Even in such a configuration, the possibility of further abnormal heat generation and explosion induction can be reduced similarly to the above embodiment.

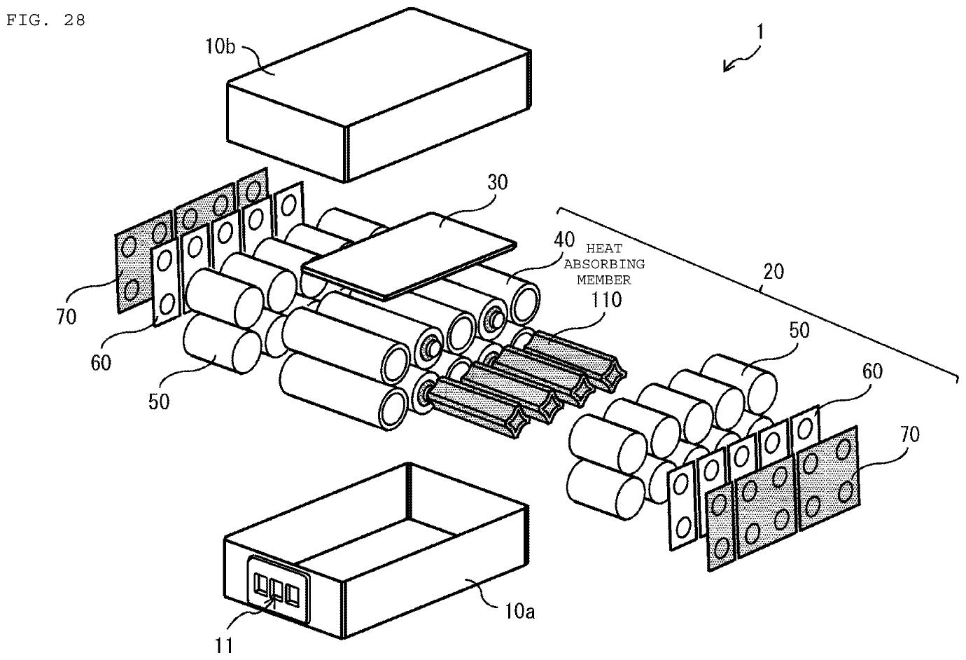

As shown in FIG. 25, for example, the heat absorbing member 60 may have a bent portion 64 that is bendable. In the bent portion 64, for example, as shown in FIG. 26, the heat absorbing agent 161 is omitted, and the laminated films 162 and 163 are joined to each other by lamination processing. The thickness of the bent portion 64 is thinner than the thickness of a portion of the heat absorbing member 60 other than the bent portion 64. Since the bent portion 64 is provided in the heat absorbing member 60, the heat absorbing member 60 can be formed into an L shape bent at the bent portion 64, for example, as shown in FIG. 27.

In the present modification, for example, as shown in FIG. 27, the plurality of metal tabs 70 may include an L-shaped metal tab 70A (first tab) provided along the side surface of the battery 40 from the first end surface 40a, and an L-shaped metal tab 70B (second tab) provided along the side surface of the battery 40 from the second end surface 40b. At this time, for example, as shown in FIG. 27, the plurality of heat absorbing members 60 may include an L-shaped heat absorbing member 60A (third heat absorbing member) provided between the battery 40 and the metal tab 70A, and an L-shaped heat absorbing member 60B (fourth heat absorbing member) provided between the battery 40 and the metal tab 70B. In such a configuration, a contact area between the heat absorbing members 60A and 60B and the battery 40, a contact area between the heat absorbing members 60A and 60B and the metal tabs 70A and 70B, and a volume of the heat absorbing members 60A and 60B and the metal tabs 70A and 70B in the battery pack 1 can be increased. As a result, the possibility of further abnormal heat generation and explosion induction can be further reduced as compared with the above embodiment.

In the present modification, the thickness of the bent portion 64 is thinner than the thickness of the portion of the heat absorbing member 60 other than the bent portion 64. As a result, the heat absorbing member 60 can be formed into an L shape bent at the bent portion 64, for example, as shown in FIG. 27. As a result, the contact area between the heat absorbing members 60A and 60B and the battery 40, the contact area between the heat absorbing members 60A and 60B and the metal tabs 70A and 70B, and the volume of the heat absorbing members 60A and 60B and the metal tabs 70A and 70B in the battery pack 1 can be increased. As a result, the possibility of further abnormal heat generation and explosion induction can be further reduced as compared with the above embodiment.

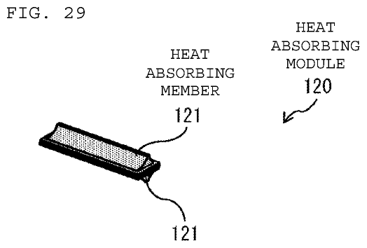

As shown in FIG. 28, for example, the battery pack 1 (battery module 20) may further include a plurality of heat absorbing members 110 in addition to the plurality of heat absorbing members 60.

The heat absorbing member 110 is embedded in a gap between the plurality of batteries 40. The heat absorbing member 110 is disposed, for example, in a gap surrounded by the four cylindrical batteries 40 adjacent to each other. At this time, a support portion 43 of holders 40a and 40b is provided with an opening at a position surrounded by the four cylindrical batteries 40 adjacent to each other, and the heat absorbing member 110 is in contact with peripheral surfaces of the four cylindrical batteries 40 via the opening of the support portion 43.

The heat absorbing member 110 has, for example, a shape corresponding to the shape of the gap. For example, in the heat absorbing member 110, a section in a direction perpendicular to an extending direction of the heat absorbing member 110 has a substantially rhombic shape. The extending direction of the heat absorbing member 110 is a direction parallel to the extending direction of each of the batteries 40 (direction in which the positive electrode 41 and the negative electrode 42 face each other). The sectional shape of the heat absorbing member 110 is not limited to a substantially rhombus shape, and may be another shape.

The heat absorbing member 110 encapsulates a heat absorbing agent, and is configured such that the heat absorbing agent leaks to the outside when the battery 40 abnormally generates heat. The heat absorbing member 110 includes, for example, a heat absorbing agent and a film covering the heat absorbing agent.

The heat absorbing agent may include a liquid containing water. The heat absorbing agent may include a hydrogel (for example, a synthetic polymer gel). Examples of the material of the synthetic polymer gel include sodium polyacrylate (PNaAA), polyvinyl alcohol (PVA), polyhydroxyethyl methacrylate (PHE-MA), and silicone hydrogel.

The heat absorbing agent may include a thermally irreversible solid material containing water. At this time, the heat absorbing agent has such hardness that the heat absorbing agent does not leak out of the heat absorbing member 110 due to dissolution, softening, or the like when heated, and can stand alone. The solid material is configured to contain glucomannan. The solid material is formed by, for example, dissolving a glucomannan powder in water to swell the glucomannan, then adding an alkaline solution, heating to gelate, and further solidifying. The acetyl group of glucomannan is deacetylated by reaction with an alkali, and a thermally irreversible solid material is formed by heating the deacetylated glucomannan. A method of producing a solid material is not limited to the above contents.

The film includes a material having a heat resistance temperature lower than the abnormal heat generation temperature (for example, about 600° C.) of the battery 40, and includes, for example, a resin material such as polyethylene, polystyrene, polypropylene, or polycarbonate. The film may include a single layer film or a laminated film. The laminated film may be, for example, a laminated sheet in which a metal layer is sandwiched between two resin layers. At this time, the two resin layers contain, for example, a resin material such as polyethylene, polystyrene, polypropylene, or polycarbonate. The metal layer includes, for example, a metal foil such as an aluminum foil.

In the present modification, the plurality of heat absorbing members 110 are embedded in the gap between the plurality of batteries 40. As a result, for example, when one battery 40 in the battery pack 1 abnormally generates heat, the film of the heat absorbing member 110 adjacent to the battery 40 that has abnormally generated heat is dissolved, and the heat absorbing agent covered with the film comes into contact with the battery 40. As a result, the battery 40 that has generated abnormal heat can be efficiently cooled by the heat absorbing agent. Therefore, the possibility of explosion induction can be reduced.

A heat absorbing module 120 as shown in FIG. 29, for example, may be provided instead of the heat absorbing member 110. The heat absorbing module 120 is embedded in the gap between the plurality of batteries 40. The heat absorbing module 120 is disposed, for example, in the gap surrounded by the four cylindrical batteries 40 adjacent to each other. At this time, the support portion 43 of the holders 40a and 40b is provided with the opening at the position surrounded by the four cylindrical batteries 40 adjacent to each other, and the heat absorbing module 120 is in contact with the peripheral surfaces of the four cylindrical batteries 40 via the opening of the support portion 43.

For example, the heat absorbing module 120 is in contact with the peripheral surfaces of the four cylindrical batteries 40 in the gap, and has a shape corresponding to the shape of the gap. For example, in the heat absorbing module 120, a section in a direction perpendicular to an extending direction of the heat absorbing module 120 has a substantially rhombic shape. The extending direction of the heat absorbing module 120 is a direction parallel to the extending direction of each of the batteries 40 (direction in which the positive electrode 41 and the negative electrode 42 face each other). The sectional shape of the heat absorbing module 120 is not limited to a substantially rhombus shape, and may be another shape.

For example, as shown in FIG. 29, the heat absorbing module 120 has a configuration in which two heat absorbing members 121 are overlapped with each other. For example, in each of the heat absorbing members 121, a section in a direction perpendicular to an extending direction of the heat absorbing member 121 has a substantially triangular shape. At this time, for example, one heat absorbing member 121 is in contact with the peripheral surfaces of the two cylindrical batteries 40 and a surface (bottom surface) of the other heat absorbing member 121 in the gap. The extending direction of the heat absorbing member 121 is a direction parallel to the extending direction of each of the batteries 40 (direction in which the positive electrode 41 and the negative electrode 42 face each other). The sectional shape of the heat absorbing member 121 is not limited to a substantially triangular shape, and may be another shape.

The heat absorbing member 121 encapsulates a heat absorbing agent, and is configured such that the heat absorbing agent leaks to the outside when the battery 40 abnormally generates heat. The heat absorbing member 121 includes, for example, a heat absorbing agent and a film covering the heat absorbing agent. The heat absorbing agent used for the heat absorbing member 121 may have a configuration common to the heat absorbing agent used for the heat absorbing member 60. The film used for the heat absorbing member 121 may have a configuration common to the film used for the heat absorbing member 121.

In the present modification, the plurality of heat absorbing modules 120 are embedded in the gap between the plurality of batteries 40. As a result, for example, when one battery 40 in the battery pack 1 abnormally generates heat, the film of the heat absorbing module 120 adjacent to the battery 40 that has abnormally generated heat is dissolved, and the heat absorbing agent covered with the film comes into contact with the battery 40. As a result, the battery 40 that has generated abnormal heat can be efficiently cooled by the heat absorbing agent. Therefore, the possibility of explosion induction can be reduced.

In the present modification, the plurality of heat absorbing members 121 may be disposed in the gap between the plurality of batteries 40 and the control board 30. The heat absorbing member 121 may be disposed, for example, in a gap surrounded by the two cylindrical batteries 40 adjacent to each other and the control board 30. At this time, the support portion 43 of the holders 40a and 40b is provided with an opening at the position surrounded by the two cylindrical batteries 40 adjacent to each other and the control board 30, and the heat absorbing member 121 is in contact with the peripheral surfaces of the two cylindrical batteries 40 via the opening of the support portion 43. Even in such a configuration, as in the present modification, the battery 40 that has generated abnormal heat can be efficiently cooled by the heat absorbing agent. Therefore, the possibility of explosion induction can be reduced.

In the present modification, the plurality of heat absorbing members 121 may be arranged in a gap between the plurality of batteries 40 and the bottom surface or the side surface of the lower case 10a. The heat absorbing member 121 may be disposed, for example, in a gap surrounded by the two cylindrical batteries 40 adjacent to each other and the bottom surface or the side surface of the lower case 10a. At this time, the support portion 43 of the holders 40a and 40b is provided with an opening at the position surrounded by the two cylindrical batteries 40 adjacent to each other and the bottom surface or the side surface of the lower case 10a, and the heat absorbing member 121 is in contact with the peripheral surfaces of the two cylindrical batteries 40 via the opening of the support portion 43. Even in such a configuration, as in the present modification, the battery 40 that has generated abnormal heat can be efficiently cooled by the heat absorbing agent. Therefore, the possibility of explosion induction can be reduced.

The application of the battery pack 1 is not particularly limited, including as applied to machines, devices, instruments, apparatuses, systems, and the like (assembly of a plurality of devices or the like) that can use the battery pack as a driving power supply, a power storage source for reserve of power, and the like.

The battery pack 1 for use as a power supply may be served as a main power supply or an auxiliary power supply. The main power supply is a power supply that is preferentially used regardless of the presence or absence of another power supply. The auxiliary power supply may be, for example, a power supply which is used instead of the main power supply, or a power supply which is switched from the main power supply according to an embodiment. When the battery pack is used as an auxiliary power supply, the main power supply is not limited to the battery pack.

Examples of the application of the battery pack 1 are as follows: electronic devices (including portable electronic devices) such as video cameras, digital still cameras, mobile phones, laptop personal computers, cordless telephones, headphone stereos, portable radios, portable televisions, and portable information terminals; portable life instruments such as electric shavers; storage devices such as a backup power supply and a memory card; power tools such as electric drills and electric saws; medical electronic devices such as pacemakers and hearing aids: electric vehicles such as electric cars (including hybrid cars); and power storage systems such as a domestic battery system that stores electric power in preparation for emergency or the like. Of course, the application of the battery pack may be an application other than the above.

Although the present technology has been described with reference to one or more embodiments, the present technology is not limited thereto, and various modifications can be made with respect to the present technology.

The case where the battery structure of the secondary battery is cylindrical has been described, for example; however, the battery structure of the secondary battery applied to the battery pack of the present technology is not particularly limited. For example, the battery structure of the secondary battery may be a rectangular type, a coin type, or the like.

In addition, the case where the secondary battery has the wound structure has been described, but the structure of the secondary battery is not particularly limited. For example, the secondary battery may have another structure such as a laminated structure.

Further, lithium has been used as an electrode reactant of the secondary battery, but the kind of the electrode reactant is not particularly limited. For example, the electrode reactant may be another element of Group 1 in the long-periodic table such as sodium or potassium, an element of Group 2 in the long-periodic table such as magnesium or calcium or another light metal such as aluminum.

Since the effects described in the present specification are merely examples, the effects of the present technology are not limited to the effects described in the present specification. Therefore, other suitable effects regarding the present technology may be obtained.

The present technology is described below in further detail according to one or more embodiments.
<1>
A battery pack including:
a plurality of secondary batteries;
a tab that electrically connects the plurality of secondary batteries; and
a heat absorbing member in which a heat absorbing agent is encapsulated in an insulating container, in which the heat absorbing member is provided between the secondary battery and the tab and in at least a part of a peripheral region of a connection portion between the secondary battery and the tab.
<2>
The battery pack according to <1>, in which
the secondary battery includes a first end surface and a second end surface facing each other, a positive electrode provided on the first end surface, and a negative electrode provided on the second end surface,
the connection portion includes a first connection portion where the positive electrode and the tab are connected, a second connection portion where the negative electrode and the tab are connected, and
the heat absorbing member is provided between the secondary battery and the tab and in at least a part of a peripheral region of the first connection portion and the second connection portion.
<3>
The battery pack according to <2>, in which the heat absorbing member has a first through hole into which the first connection portion is inserted and a second through hole into which the second connection portion is inserted.
<4>
The battery pack according to <2>, in which the heat absorbing member has at least one of a first through hole into which the first connection portion is fitted and a second through hole into which the second connection portion is fitted.
<5>
The battery pack according to <3> or <4>, in which the first connection portion and the second connection portion have a circular shape in plan view, the first through hole has a circular shape having a diameter equal to or larger than a diameter of the first connection portion in plan view, and the second through hole has a circular shape having a diameter equal to or larger than a diameter of the second connection portion in plan view.
<6>
The battery pack according to any one of <2> to <5>, in which
the secondary battery includes a slit portion provided around the positive electrode and a cracking valve provided in the slit portion, and
the heat absorbing member is provided to cover the slit portion.
<7>
The battery pack according to <6>, in which the heat absorbing member is also provided inside the slit portion.
<8>
The battery pack according to any one of <1> to <7>, in which the heat absorbing member is in contact with the tab.
<9>
The battery pack according to any one of <2> to <7>, in which the heat absorbing member is in contact with the first end surface and the second end surface.
<10>
The battery pack according to any one of <2> to <7>, in which
the first end surface of a first secondary battery in the plurality of secondary batteries and a second end surface of a second secondary battery in the plurality of secondary batteries are arranged in a same plane,
the tab is electrically connected to the positive electrode on the first end surface of the first secondary battery and the negative electrode on the second end surface of the second secondary battery, and
the heat absorbing member is provided between the first end surface of the first secondary battery and the second end surface of the second secondary battery and the tab and in at least a part of the peripheral region of the first connection portion and the second connection portion.
<11>
The battery pack according to any one of <2> to <7>, in which
a plurality of the first end surfaces and a plurality of the second end surfaces are alternately arranged in a same plane,
each of the tabs is electrically connected to the positive electrode on the first end surface of the first secondary battery and the negative electrode on the second end surface of the second secondary battery, and
each of the heat absorbing members is provided between the first end surface of the first secondary battery and the second end surface of the second secondary battery and the tab and in at least a part of the peripheral region of the first connection portion and the second connection portion.
<12>
The battery pack according to <10>, in which the heat absorbing member is in contact with the tab.
<13>
The battery pack according to any one of <10> to <12>, in which the heat absorbing member is in contact with the first end surface and the second end surface.
<14>
The battery pack according to any one of <1> to <9>, in which
the heat absorbing member includes a first heat absorbing member provided between the secondary battery and the tab, and a second heat absorbing member provided at a position facing the secondary battery via the tab, and the first heat absorbing member and the second heat absorbing member are in contact with the tab.
<15>
The battery pack according to any one of <10> to <13>, in which
the heat absorbing member includes a first heat absorbing member provided between the first end surface of the first secondary battery and the second end surface of the second secondary battery and the tab, and a second heat absorbing member provided at a position facing the first end surface of the first secondary battery and the second end surface of the second secondary battery via the tab, and
the first heat absorbing member and the second heat absorbing member are in contact with the tab.
<16>
The battery pack according to any one of <2> to <7>, in which
the tab includes an L-shaped first tab provided along a side surface of the secondary battery from the first end surface and an L-shaped second tab provided along the side surface of the secondary battery from the second end surface, and
the heat absorbing member includes an L-shaped third heat absorbing member provided between the secondary battery and the first tab, and an L-shaped fourth heat absorbing member provided between the secondary battery and the second tab.
<17>
The battery pack according to <16>, in which in the third heat absorbing member and the fourth heat absorbing member, a thickness of a bent portion in the L shape is thinner than a thickness of a portion other than the bent portion in the L shape.
<18>
The battery pack according to any one of <1> to <17>, in which the heat absorbing member is also provided in a gap between the plurality of secondary batteries.
<19>
A battery pack including:
a plurality of secondary batteries;
a tab that electrically connects the plurality of secondary batteries; and
a heat absorbing member in which a heat absorbing agent is encapsulated in an insulating container,
in which the secondary battery includes a first end surface and a second end surface facing each other, a positive electrode provided on the first end surface, and a negative electrode provided on the second end surface, and the heat absorbing member is provided between the secondary battery and the tab and in at least a part of a peripheral region of the positive electrode.
<20>
A battery pack including:
a plurality of secondary batteries;
a tab that electrically connects the plurality of secondary batteries; and
a heat absorbing member in which a heat absorbing agent is encapsulated in an insulating container,
in which the secondary battery includes a first end surface and a second end surface facing each other, a positive electrode provided on the first end surface, and a negative electrode provided on the second end surface, the first end surface of a first secondary battery in the plurality of secondary batteries and the second end surface of the second secondary battery in the plurality of secondary batteries are arranged in a same plane, the tab is electrically connected to the positive electrode on the first end surface of the first secondary battery and the negative electrode on the second end surface of the second secondary battery, the heat absorbing member is provided between the first end surface of the first secondary battery and the second end surface of the second secondary battery and the tab, and the heat absorbing member is in contact with the tab.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a plurality of secondary batteries;
a tab that electrically connects the plurality of secondary batteries; and
a heat absorbing member in which a heat absorbing agent is encapsulated in an insulating container,
wherein the heat absorbing member is provided between the secondary battery and the tab and in at least a part of a peripheral region of a connection portion between the secondary battery and the tab.

2. The battery pack according to claim 1, wherein
the secondary battery includes a first end surface and a second end surface facing each other, a positive electrode provided on the first end surface, and a negative electrode provided on the second end surface,
the connection portion includes a first connection portion where the positive electrode and the tab are connected, a second connection portion where the negative electrode and the tab are connected, and
the heat absorbing member is provided between the secondary battery and the tab and in at least a part of a peripheral region of the first connection portion and the second connection portion.

3. The battery pack according to claim 2, wherein the heat absorbing member has a first through hole into which the first connection portion is inserted and a second through hole into which the second connection portion is inserted.

4. The battery pack according to claim 2, wherein the heat absorbing member has at least one of a first through hole into which the first connection portion is fitted and a second through hole into which the second connection portion is fitted.

5. The battery pack according to claim 3, wherein the first connection portion and the second connection portion have a circular shape in plan view, the first through hole has a circular shape having a diameter equal to or larger than a diameter of the first connection portion in plan view, and the second through hole has a circular shape having a diameter equal to or larger than a diameter of the second connection portion in plan view.

6. The battery pack according to claim 2, wherein
the secondary battery includes a slit portion provided around the positive electrode and a cracking valve provided in the slit portion, and
the heat absorbing member is provided to cover the slit portion.

7. The battery pack according to claim 6, wherein the heat absorbing member is also provided inside the slit portion.

8. The battery pack according to claim 1, wherein the heat absorbing member is in contact with the tab.

9. The battery pack according to claim 2, wherein the heat absorbing member is in contact with the first end surface and the second end surface.

10. The battery pack according to claim 2, wherein
the first end surface of a first secondary battery in the plurality of secondary batteries and a second end surface of a second secondary battery in the plurality of secondary batteries are arranged in a same plane,
the tab is electrically connected to the positive electrode on the first end surface of the first secondary battery and the negative electrode on the second end surface of the second secondary battery, and
the heat absorbing member is provided between the first end surface of the first secondary battery and the second end surface of the second secondary battery and the tab and in at least a part of the peripheral region of the first connection portion and the second connection portion.

11. The battery pack according to claim 2, wherein
a plurality of the first end surfaces and a plurality of the second end surfaces are alternately arranged in a same plane,
each of the tabs is electrically connected to the positive electrode on the first end surface of the first secondary battery and the negative electrode on the second end surface of the second secondary battery, and
each of the heat absorbing members is provided between the first end surface of the first secondary battery and the second end surface of the second secondary battery and the tab and in at least a part of the peripheral region of the first connection portion and the second connection portion.

12. The battery pack according to claim 10, wherein the heat absorbing member is in contact with the tab.

13. The battery pack according to claim 10, wherein the heat absorbing member is in contact with the first end surface and the second end surface.

14. The battery pack according to claim 1, wherein
the heat absorbing member includes a first heat absorbing member provided between the secondary battery and the tab, and a second heat absorbing member provided at a position facing the secondary battery via the tab, and
the first heat absorbing member and the second heat absorbing member are in contact with the tab.

15. The battery pack according to claim 10, wherein
the heat absorbing member includes a first heat absorbing member provided between the first end surface of the first secondary battery and the second end surface of the second secondary battery and the tab, and a second heat absorbing member provided at a position facing the first end surface of the first secondary battery and the second end surface of the second secondary battery via the tab, and
the first heat absorbing member and the second heat absorbing member are in contact with the tab.

16. The battery pack according to claim 2, wherein
the tab includes an L-shaped first tab provided along a side surface of the secondary battery from the first end surface and an L-shaped second tab provided along the side surface of the secondary battery from the second end surface, and
the heat absorbing member includes an L-shaped third heat absorbing member provided between the secondary battery and the first tab, and an L-shaped fourth heat absorbing member provided between the secondary battery and the second tab.

17. The battery pack according to claim 16, wherein in the third heat absorbing member and the fourth heat absorbing member, a thickness of a bent portion in the L shape is thinner than a thickness of a portion other than the bent portion in the L shape.

18. The battery pack according to claim 1, wherein the heat absorbing member is also provided in a gap between the plurality of secondary batteries.

19. A battery pack comprising:
a plurality of secondary batteries;
a tab that electrically connects the plurality of secondary batteries; and
a heat absorbing member in which a heat absorbing agent is encapsulated in an insulating container,
wherein the secondary battery includes a first end surface and a second end surface facing each other, a positive electrode provided on the first end surface, and a negative electrode provided on the second end surface, and the heat absorbing member is provided between the secondary battery and the tab and in at least a part of a peripheral region of the positive electrode.

20. A battery pack comprising:
a plurality of secondary batteries;
a tab that electrically connects the plurality of secondary batteries; and
a heat absorbing member in which a heat absorbing agent is encapsulated in an insulating container,
wherein the secondary battery includes a first end surface and a second end surface facing each other, a positive electrode provided on the first end surface, and a negative electrode provided on the second end surface, the first end surface of a first secondary battery in the plurality of secondary batteries and the second end surface of the second secondary battery in the plurality of secondary batteries are arranged in a same plane, the tab is electrically connected to the positive electrode on the first end surface of the first secondary battery and the negative electrode on the second end surface of the second secondary battery, the heat absorbing member is provided between the first end surface of the first secondary battery and the second end surface of the second secondary battery and the tab, and the heat absorbing member is in contact with the tab.
